(19) United States
(12) Patent Application Publication
(10) Pub. No.: US 2023/0102957 A1
(43) Pub. Date: Mar. 30, 2023

(54) DIN RAIL MOUNTING ADAPTER

(71) Applicant: James David FISHER, Marietta, GA (US)

(72) Inventor: James David FISHER, Marietta, GA (US)

(21) Appl. No.: 17/953,682

(22) Filed: Sep. 27, 2022

Related U.S. Application Data
(60) Provisional application No. 63/248,767, filed on Sep. 27, 2021.

(51) Int. Cl. F21V 21/34

(52) U.S. Cl. CPC F21V 21/34

(57) ABSTRACT

A DIN rail mounting adapter configured for removable attachment to a DIN rail including first and second pairs of spaced-apart supports. In example embodiments, one of the supports includes one or more openings formed therethrough for receiving a component or assembly, such as an LED light assembly. In example embodiments, another one of the supports includes at least one engagement feature configured for removable attachment with a DIN rail.

### CROSS-REFERENCE TO RELATED APPLICATION

This application claims priority to U.S. Provisional Patent Application Ser. No. 63/248,767 filed Sep. 27, 2021, the entirety of which is incorporated by reference herein.

### TECHNICAL FIELD

The present invention relates generally to the field of electrical connectors and mounting components and adapters, and more particularly to DIN rail mounting adapters.

### SUMMARY OF THE INVENTION

Example embodiments of the present invention provide a DIN rail mounting adapter for attachment to a DIN rail. In example embodiments, the DIN rail mounting adapter includes a generally rectangular profile having a first pair of spaced-apart sides and a second pair of spaced-apart sides. In example embodiments, at least one side of at least one of the first or second pairs of spaced-apart sides includes at least one opening formed therein, and wherein another side of the first or second pairs of spaced-apart sides includes engagement features for attachment with a DIN rail.

In one aspect, the present invention relates to a DIN rail mounting adapter having a generally rectangular profile including first and second pairs of spaced-apart supports, wherein at least one of the supports has at least one opening formed therein. In one example, at least one of the supports includes two or more openings formed therethrough. In one example, the at least one opening is configured to receive an electrical component, for example, an LED light assembly according to some examples.

In another aspect, the present invention relates to a DIN rail mounting adapter including a first pair of spaced-apart supports and a second pair of spaced-apart supports, wherein one of the supports of the first and second pair of spaced-apart supports include one or more openings formed therethrough, and wherein one of the supports of the first and second pair of spaced-apart supports includes at least one engagement feature configured for removable engagement with a DIN rail.

In yet another aspect, the present invention relates to a DIN rail mounting adapter including a first pair of spaced-apart supports and a second pair of spaced-apart supports. In example embodiments, one of the supports of the first and second pair of spaced-apart supports includes one or more openings formed therethrough, and wherein the other one of the supports of the first and second pair of spaced-apart supports includes at least one engagement feature configured for removable engagement with a DIN rail.

In example embodiments, the support comprises two openings formed therein. In example embodiments, the openings are circular. In example embodiments, the openings comprise a diameter of about 14 millimeters. In example embodiments, the openings comprise a diameter of about 22 millimeters. In example embodiments, at least one of the one or more openings is configured for receiving a light component or assembly.

In yet another aspect, the present invention relates to a mounting adapter including a first pair of spaced-apart supports and a second pair of spaced-apart supports, wherein one of the supports of the first and second pair of spaced-apart supports include one or more openings formed therethrough, and wherein one of the supports of the first and second pair of spaced-apart supports include at least one engagement feature configured for removable engagement with a DIN rail.

In example embodiments, the mounting adapter is generally rectangular. In example embodiments, the support comprises at least one opening formed therein. In example embodiments, the at least one opening is configured to receive an electrical component. In example embodiments, the electrical component comprises an LED light assembly. In example embodiments, the support comprises two openings formed therein. In example embodiments, the openings generally comprise a diameter of about 14 millimeters. In example embodiments, the openings generally comprise a diameter of about 22 millimeters.

In yet another aspect, the present invention relates to an adapter configured for retaining one or more electrical assemblies, the adapter being removably attachable to a DIN rail, the adapter including a plurality of supports, wherein one of the supports is configured for receiving the electrical assemblies and wherein another one of the supports configured for removable attachment of the adapter to the DIN rail.

In example embodiments, the electrical assembly comprises an LED light assembly. In example embodiments, at least one of the supports comprises a passageway so as to receive at least a portion of an electrical assembly. In example embodiments, a pair of the plurality of supports are generally offset from each other so as to define a width of about width W of about 62.5 millimeters. In example embodiments, a pair of the plurality of supports are generally offset from each other so as to define height of about 58 millimeters. In example embodiments, the adapter comprises a thickness of about 19.5 millimeters.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows a front perspective assembly view of an adapter removably attached to a DIN rail, the adapter comprising two light assemblies removably connected therewith.

FIG. 2 shows a rear perspective assembly view of the adapter of FIG. 1.

FIG. 3 shows a front perspective view of the adapter of FIG. 1.

FIG. 4 is a plan side view of the adapter shown in FIG. 3.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

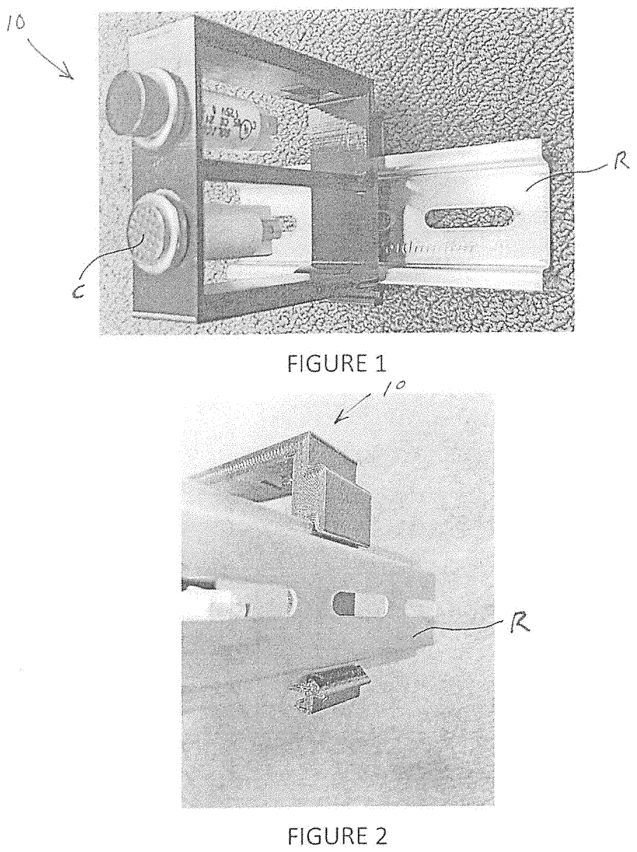

With reference now to the drawing figures, wherein like reference numbers represent corresponding parts throughout the several views, FIGS. 1-4 show a DIN rail mounting adapter 10 for removable attachment with a DIN rail R according to example embodiments of the present invention. For example, DIN (e.g., “Deutsche Institute von Normen” or “German Institute of Standards”), is a worldwide standard ensuring dimensional uniformity for products regardless of the manufacturer. The DIN rail R is typically formed of metal, which typically is generally elongate and comprises a generally central channel and oppositely opposed and outwardly-projecting flanges for removable attachment to a portion of the mounting adapter 10.

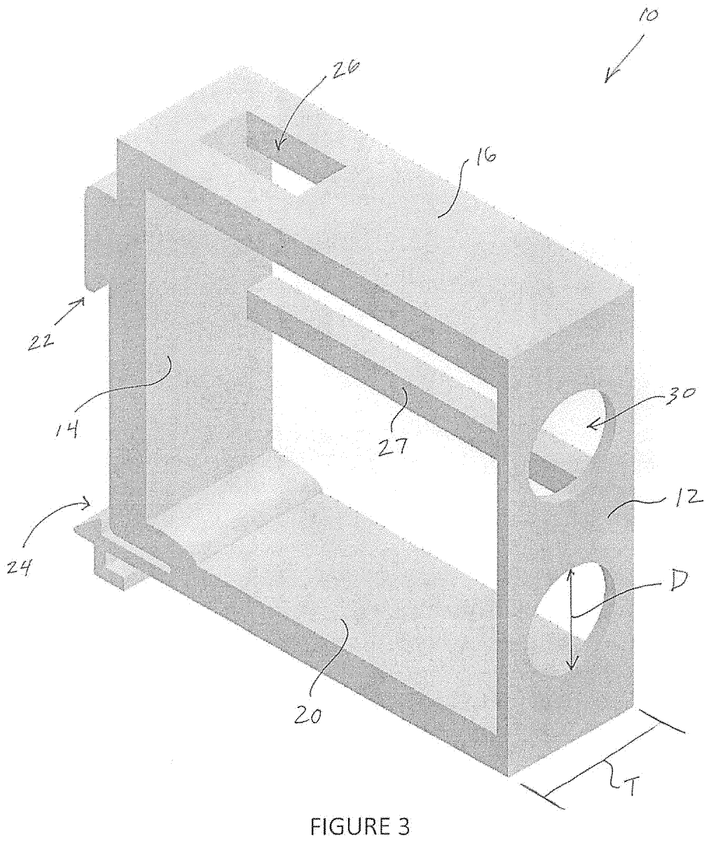

According to example embodiments, the mounting adapter 10 is generally rectangular in shape and comprises a first pair of spaced-apart sides or supports 12, 14 and a second pair of spaced-apart sides or supports 16, 20 (see FIG. 3). In example embodiments, the support 12 comprises one or more openings 30 formed therein, for example, which can be sized as desired and adapted to receive an electrical component C, for example, such as an LED light assembly or other component or assembly. According to example embodiments, the electrical component can be sized and shaped as desired, for example, and can comprise any desired hardware, mechanical assemblies, electrical components and/or other desired assemblies and components. According to example embodiments, the LED light assemblies can be removably connected to the mounting adapter, and for example, can be interchanged or removed as desired. According to example embodiments, LED light assemblies are generally colored as desired, for example, wherein one may be green to indicate proper operation, and for example, the other being red to indicate a warning, malfunction or other machine issue or error. In example embodiments, one or more portions of the light assemblies (or other desired components) can be generally flush with a surface the support 12, or for example, generally raised a distance beyond a surface of the support 12.

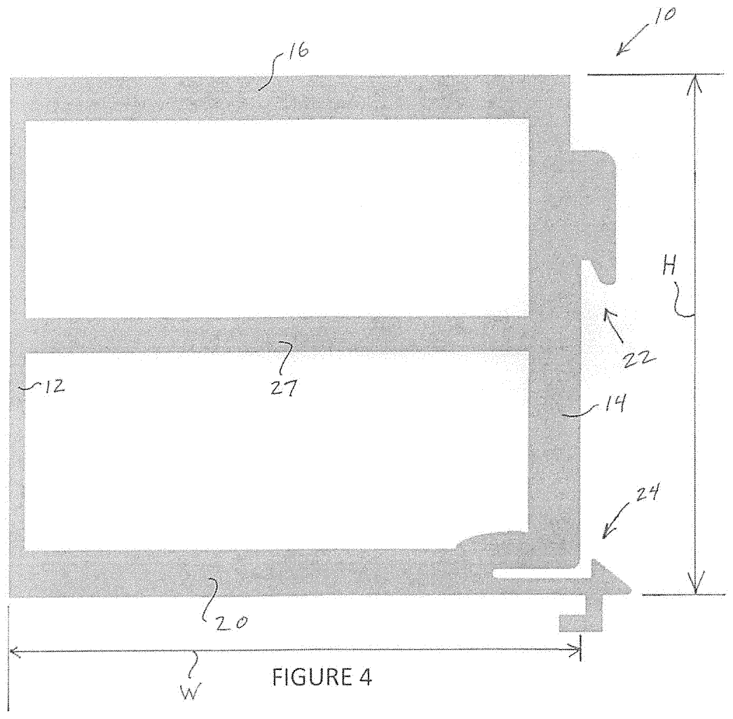

The support 14 is generally parallel and spaced-apart a width W of about 2.46 inches (62.5 millimeters) from the support 12 (see FIG. 4). In example embodiments, the support 14 comprises engagement features 22, 24 that are configured for engagement with the DIN rail R, for example, so as to allow the mounting adapter 10 to be removably attachable to the DIN rail R.

In example embodiments, the engagement feature 22 comprises an outwardly extending finger or projection, and wherein a lip is formed by the projection so as to permit receiving one of the flanges of the DIN rail R. The engagement feature 24 comprises a generally resiliently flexible arm and an end projection at the free end thereof, for example, to permit a snap-like engagement of the end projection with the other flange of the DIN rail R. A relief edge or projection can be provided so as to assist in flexing the engagement feature 24 outwardly so as to disengage the same from the respective flange of the DIN rail R.

In the example embodiments and as described above, the supports 12, 14 are generally spaced apart to define a width W of about 2.46 inches (62.5 millimeters). The supports 16, 20 are generally configured to be oriented parallel and define a height H of about 2.3 inches (58 millimeters). In example embodiments, the mounting adapter 10 comprises a thickness T of about 0.767 inches (19.5 millimeters). In other example embodiments, the width W, height H and thickness T can be chosen as desired.

In example embodiments, the one or more openings 30 of the support 12 can be configured for retaining a variety of components or other mounting hardware, assemblies or other desired componentry. According to one example embodiment, the openings are configured for the removable attachment of an electrical component assembly, for example, such as a light assembly C (see FIG. 1). According to example embodiments, the openings are generally circular and comprise a diameter D of between about 0.551 inches (14 millimeters) and about 0.866 inches (22 millimeters) (see FIG. 3). According to other example embodiments, the openings 30 can be shaped and sized as desired.

According to example embodiments of the present invention, the support 16 can comprise one or more openings of any desired size and shape, for example, so as to provide a passageway for any electrical wiring needed to power the one or more light assemblies C, or for example various other electrical components that may be mounted to the adapter 10. Furthermore, a support 27 can be provided between two or more of the supports 12, 14, for example, so as to enhance the structural integrity of the mounting adapter 10. Optionally, another support can be provided between the supports 16, 20, and/or additional support segments can extend from the support 27 to the supports 16, 20, for example, to define a “+” shaped support. Or for example, the entirety of the support may be checkered, for example, to comprise an matrix of alternating segments of openings and supports.

In example embodiments, the mounting adapter 10 can be formed from any desired material. In example embodiments, the mounting adapter 10 is formed from a plastic material, for example, such as PETG. Optionally, the adapter 10 can be formed from various other plastic or polymer materials as desired. According to other example embodiments, the adapter 10 can be formed from other materials including natural materials, unnatural materials, metals, composites, plastics, polymers, rubbers and/or combinations thereof as desired.

While the invention has been described with reference to preferred and example embodiments, it will be understood by those skilled in the art that a variety of modifications, additions and deletions are within the scope of the invention, as defined by the following claims.

What is claimed is:

1. A DIN rail mounting adapter comprising a first pair of spaced-apart supports and a second pair of spaced-apart supports, wherein one of the supports of the first and second pair of spaced-apart supports comprises one or more openings formed therethrough, and wherein one of the supports of the first and second pair of spaced-apart supports comprises at least one engagement feature configured for removable engagement with a DIN rail.

2. The DIN rail mounting adapter of claim 2, wherein the support comprises two openings formed therein.

3. The DIN rail mounting adapter of claim 2, wherein the openings are circular.

4. The DIN rail mounting adapter of claim 4, wherein the openings comprise a diameter of about 14 millimeters.

5. The DIN rail mounting adapter of claim 4, wherein the openings comprise a diameter of about 22 millimeters.

6. The DIN rail mounting adapter of claim 2, wherein at least one of the one or more openings is configured for receiving a light component or assembly.

7. A mounting adapter comprising a first pair of spaced-apart supports and a second pair of spaced-apart supports, wherein one of the supports of the first and second pair of spaced-apart supports comprises one or more openings formed therethrough, and wherein one of the supports of the first and second pair of spaced-apart supports comprises at least one engagement feature configured for removable engagement with a DIN rail.

8. The mounting adapter of claim 7, wherein the mounting adapter is general rectangular.

9. The mounting adapter of claim 7, wherein the support comprises at least one opening formed therein.

10. The mounting adapter of claim 9, wherein the at least one opening is configured to receive an electrical component.

11. The mounting adapter of claim 10, wherein the electrical component comprises an LED light assembly.

12. The mounting adapter of claim 7, wherein the support comprises two openings formed therein.

13. The mounting adapter of claim 7, wherein the openings generally comprise a diameter of about 14 millimeters.

14. The mounting adapter of claim 7, wherein the openings generally comprise a diameter of about 22 millimeters.

15. An adapter configured for retaining one or more electrical assemblies, the adapter being removably attachable to a DIN rail, the adapter comprising a plurality of supports, wherein one of the supports is configured for receiving the electrical assemblies and wherein another one of the supports configured for removable attachment of the adapter to the DIN rail.

16. The adapter of claim 15, wherein the electrical assembly comprises an LED light assembly.

17. The adapter of claim 15, wherein at least one of the supports comprises a passageway so as to receive at least a portion of an electrical assembly.

18. The adapter of claim 15, wherein a pair of the plurality of supports are generally offset from each other so as to define a width of about width W of about 62.5 millimeters.

19. The adapter of claim 15, wherein a pair of the plurality of supports are generally offset from each other so as to define height of about 58 millimeters.

20. The adapter of claim 15, wherein the adapter comprises a thickness of about 19.5 millimeters.
